(19) United States
(12) Patent Application Publication
(10) Pub. No.: US 2026/0131837 A1
(43) Pub. Date: May 14, 2026

(54) BARROW TOPPER

(71) Applicants: Kyle Buck, Alpharetta, GA (US); Andrew Rawlins, Roswell, GA (US)

(72) Inventors: Kyle Buck, Alpharetta, GA (US); Andrew Rawlins, Roswell, GA (US)

(21) Appl. No.: 18/941,009

(22) Filed: Nov. 8, 2024

(51) Int. Cl. B62B 1/20; B62B 5/00

(52) U.S. Cl. CPC B62B 1/204; B62B 5/0013; B62B 2204/00

(57) ABSTRACT

A wheel barrow having a wheel barrow main body and a wheel barrow cover is disclosed. The wheel barrow main body may include a main body top end and a main body bottom end. The wheel barrow main body may include a container configured to store items. The wheel barrow cover may be configured to be attached to the main body top end. The wheel barrow cover may include a cover front portion and a cover back portion. The cover front portion may be pivotally connected to the cover back portion via a hinge, and the cover front portion may be configured to move between an open position and a closed position. A profile of the wheel barrow main body is same as a profile of the wheel barrow cover.

### TECHNICAL FIELD

The present disclosure relates to a wheel barrow, and more particularly to a barrow topper or cover for the wheel barrow.

### BACKGROUND

Wheel barrows are often used in gardening, agriculture, and small-scale construction applications, to easily move loads from a first location to a second location. For instance, a user may use the wheel barrow to move or transport piles of dirt, weeds, leaves, tools, compost, soil, or any other small load.

The wheel barrow is a small, hand-operated vehicle that typically consists of a single wheel at a wheel barrow front end, a bucket to store material, and handles at a wheel barrow back end. Using a wheel barrow is generally very efficient in transporting material, however, in some cases, there may be spillage when the material inside the bucket shifts or overflows during transportation, which may be undesirable and may cause inconvenience.

Thus, there is a need for a system that enables a user to use the wheel barrow without any spillage and inconvenience.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an isometric view of a wheel barrow with a wheel barrow cover in a closed position, in accordance with the present disclosure.

FIG. 2 depicts an isometric view of a wheel barrow with a wheel barrow cover in an open position, in accordance with the present disclosure.

FIG. 3 depicts a disassembled view of a wheel barrow and a wheel barrow cover in accordance with the present disclosure.

FIG. 4 depicts a back view of a wheel barrow with a wheel barrow cover in an open position, in accordance with the present disclosure.

FIG. 5 depicts an example storage position of a wheel barrow cover inside a wheel barrow main body in accordance with the present disclosure.

### DETAILED DESCRIPTION

### Overview

The present disclosure is directed to a wheel barrow that may assist a user to store and transport piles of dirt, weeds, leaves, tools, compost, soil, or any other small load from a first location to a second location. A user may use the wheel barrow in gardening, agriculture, and small-scale construction applications.

The wheel barrow may include a wheel barrow main body (e.g., a bucket or a storage container), a single wheel or multiple wheels, first and second handles, and a frame that connects the wheel barrow main body, the wheel or multiple wheels, and the handles. The wheel barrow may further include a wheel barrow cover that may be removably attached to the wheel barrow main body via one or more fasteners (e.g., clamps). In an exemplary aspect, the wheel barrow cover may be attached to a wheel barrow main body top end. In some aspects, a wheel barrow main body profile (e.g., dimensions, shape etc.) may be same as a wheel barrow cover profile, thereby providing additional capacity or storage volume to the wheel barrow. Stated another way, since the profiles of the wheel barrow main body and the wheel barrow cover are the same, the user may increase the wheel barrow's storage capacity/volume when the user attaches the wheel barrow cover to the wheel barrow main body.

The wheel barrow main body may include a front sidewall, a back sidewall, a left sidewall, a right sidewall, and a bottom wall. Similarly, the wheel barrow cover may include a cover front sidewall, a cover back sidewall, a cover left sidewall, a cover right sidewall, and a cover top wall. The dimensions or structures of the front sidewall, the back sidewall, the left sidewall, the right sidewall, and the bottom wall may be the same as the dimensions or structures of the cover front sidewall, the cover back sidewall, the cover left sidewall, the cover right sidewall, and the cover top wall, respectively. The cover front sidewall may form a cover front portion, and the cover back sidewall, the cover left sidewall, the cover right sidewall, and the cover top wall may form the cover back portion.

In some aspects, the cover front portion may be pivotally connected to the cover back portion via a hinge. Specifically, the cover front sidewall may be pivotally connected to the cover top wall. The cover front portion may move between an open position and a closed position. In the closed position, the wheel barrow cover may completely cover the wheel barrow main body, and may not allow/enable loading or unloading of material to/from the wheel barrow main body and prevent spillage of material from the front end, the rear end, and the sides of the wheel barrow. In the open position, the wheel barrow cover may partially uncover or partially cover (e.g., uncover 15-20% or 10-50% of a wheel barrow total length) the wheel barrow main body. In some aspects, in the open position, the cover back portion may be attached to the wheel barrow main body and enclose (or provide support to) the material stored in the wheel barrow main body. In the fully open position, the cover front portion may be detached from the wheel barrow main body (e.g., from the wheel barrow front portion) and may latch (or may be positioned) on the cover back portion.

The present disclosure discloses a wheel barrow cover that may provide additional capacity or storage volume to the wheel barrow by extending the use of the wheel barrow main body beyond its standard edge/sidewalls. The wheel barrow cover prevents the material from falling out from the wheel barrow when in transit. In some aspects, the wheel barrow main body and the wheel barrow cover may be made of plastic or steel. The use of steel enables the user to safely burn the material inside the wheel barrow main body.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

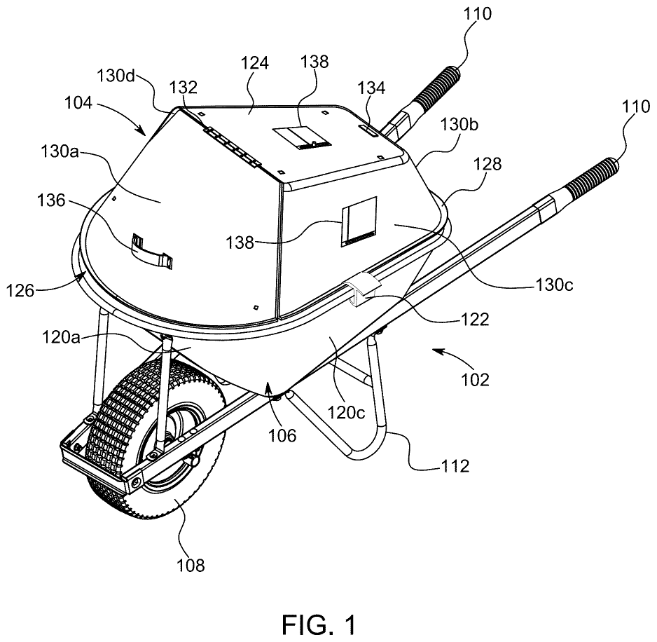

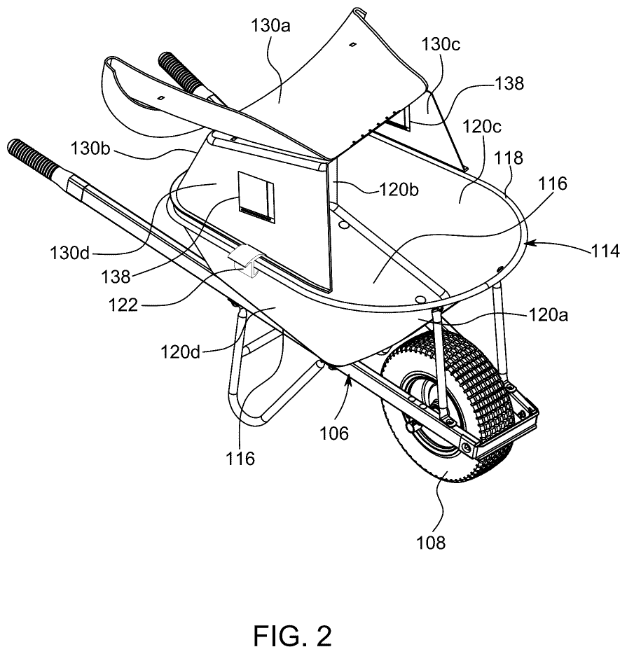

FIG. 1 depicts an isometric view of a wheel barrow 102 with a wheel barrow cover 104 in a closed position, in accordance with the present disclosure. FIG. 1 will be described in conjunction with FIGS. 2, 3, and 4.

The wheel barrow 102 may include a plurality of components including, but not limited to, a wheel barrow main body 106, a wheel 108, first and second handles 110 (collectively referred to as handle 110), and a frame 112. The wheel 108 may be disposed at a wheel barrow front end. The wheel 108 may be of any size and type. In some aspects, the wheel barrow 102 may include two wheels instead of one wheel shown in FIG. 1.

The handle 110 may be located at a wheel barrow back end, and may be made of any material such as wood, plastic (e.g., High-density polyethylene (HDPE)), steel, aluminum, and/or the like. A user may use the handle 110 to maneuver the wheel barrow movement. For example, the user may push both the handles 110 forward away from the user's body when the user desires to move the wheel barrow 102 forward. Similarly, the user may pull both the handles 110 backward towards the user's body when the user desires to move the wheel barrow 102 in reverse. In the exemplary aspect depicted in FIG. 1, the handles 110 are disposed at a bottom rear portion of the wheel barrow 102, however, such depicted should not be construed as limiting. The handles 110 may be located at any other location on the wheel barrow 102, which may enable the user to conveniently maneuver the wheel barrow movement.

The frame 112 may be a structural support that connects the wheel barrow main body 106, the wheel 108, and the handle 110. The frame 112 may be made of any material such as wood, plastic, steel, aluminum, and/or the like.

The wheel barrow main body 106 may be a bucket (or a shallow container) that may store material to be transported from a first location to a second location. The bucket may be a hollow body that may store the material in a bucket interior portion. The material may include, but are not limited to, piles of dirt, weeds, leaves, tools, compost, soil, or any other small load. The wheel barrow main body 106 may be made of any material. In some aspects, the wheel barrow main body 106 may be made of plastic (e.g., HDPE). In further aspects, the wheel barrow main body 106 may be made of steel or any other metal. The wheel barrow main body 106 may be of any size based on the wheel barrow's usage or application area. In an exemplary aspect, the wheel barrow main body 106 capacity/volume may be in a range of 3-11 cubic feet.

The wheel barrow main body 106 may include a main body top end 114 and a main body bottom end 116 (or main body bottom wall 116), as shown in FIG. 2. The main body top end 114 may be an open end and the main body bottom end 116 may be a closed end. The main body bottom end 116 may face towards the ground surface when the wheel barrow 102 is placed on the ground. The main body bottom end 116 may be attached to the frame 112 and/or the handle 110. The main body top end 114 may be opposite to the main body bottom end 116. In some aspects, the main body top end 114 may include a first rim 118 that may be positioned on a main body top end 114 entire periphery. The first rim 118 may be a circular or oval structure, which provides a strong edge that reinforces the wheel barrow main body structure. The first rim 118 helps maintain the wheel barrow main body shape under load, thereby preventing deformation when carrying heavy material.

The wheel barrow main body 106 may further include sidewalls including a front sidewall 120a, a back sidewall 120b, a left sidewall 120c, and a right sidewall 120d. The front sidewall 120a may be located towards the wheel barrow front end. The back sidewall 120b may be located towards the wheel barrow back end, and disposed opposite to the front sidewall 120a. Interior surfaces of the front sidewall 120a, the back sidewall 120b, the left sidewall 120c, the right sidewall 120d and the main body bottom wall 116 may contact the material when the material may be loaded in the wheel barrow main body 106/wheel barrow 102.

The wheel barrow main body 106 may be of any shape. In some aspects, the wheel barrow main body 106 may be trapezoidal in shape (or substantially trapezoidal in shape). In such a scenario, the main body top end 114 may be parallel (or substantially parallel) to the main body bottom wall 116. In some aspects, the main body bottom wall 116 may be slanted or inclined at a predefined non-zero angle relative to the ground surface, to facilitate easy unloading of material from the wheel barrow main body 106. In further aspects, the sidewalls including the front sidewall 120a, the back sidewall 120b, the left sidewall 120c, and the right sidewall 120d may be slanted outwards away from the main body bottom wall 116. Stated another way, in this case, the sidewalls may be inclined at a predefined angle (which is not 90 degrees) relative to the main body bottom wall 116. Such a shape of the sidewalls increases the storage volume of inside the wheel barrow main body 106, and also makes it easier for the user to load/unload material into/from the wheel barrow main body 106. In other aspects, one or more sidewalls may be straight or disposed perpendicular to the main body bottom wall 116.

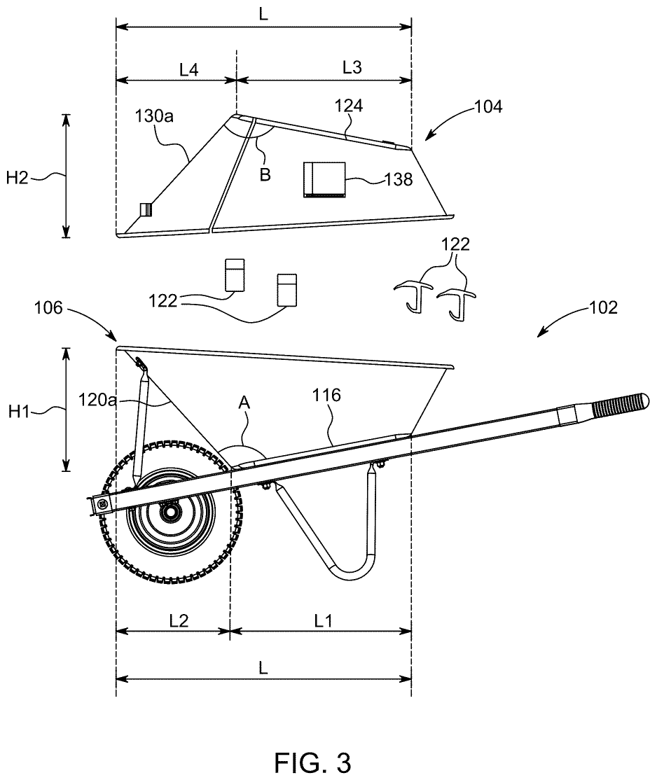

In some aspects, the front sidewall 120a may be curved (or have an arc-shape) and slanted at a predefined angle (which is not 90 degrees) relative to the main body bottom wall 116, to facilitate easy unloading of material from the wheel barrow main body 106. In an exemplary aspect, the front sidewall 120a may be slanted at a first predefined angle “A” relative to the main body bottom wall 116, as shown in FIG. 3. The predefined angle “A” may be greater than 90 degrees and less than 180 degrees, to enable easy unloading of material from the wheel barrow main body 106.

The wheel barrow main body 106 may further include a main body front portion and a main body back portion. The main body front portion may be located at the wheel barrow front end. Stated another way, the main body front portion may be located in proximity to the wheel 108. The main body back portion may be located at the wheel barrow back end. Stated another way, the main body back portion may be located in proximity to the handle 110 or the user (when the user may be moving the wheel barrow 102).

In some aspects, the front sidewall 120a may form the main body front portion, and the back sidewall 120b, the left sidewall 120c, the right sidewall 120d, and the main body bottom wall 116 may form the main body back portion. Stated another way, the main body front portion may include the front sidewall 120a, and the main body back portion may include the back sidewall 120b, the left sidewall 120c, the right sidewall 120d, and the main body bottom wall 116. The main body back portion may facilitate material storage, and the main body front portion may facilitate easy material unloading from the wheel barrow main body 106 without causing any spillage. In some aspects, the wheel barrow main body 106 may be tapered to further facilitate easy unloading. In such a scenario, a main body back portion width may be greater than a main body front portion width.

In some aspects, a main body back portion length “L1” may be greater than a main body front portion length “L2”. In some aspects, the main body back portion length “L1” may be in a range of 60-90% of a total length “L” of the wheel barrow main body 106 (which is equivalent to a sum of “L1” and “L2”), and the main body front portion length “L2” may be in a range of 10-40% of the total length “L”. In another exemplary aspect, the main body front portion length “L2” may be in a range of 15-20% or 10-50% of the total length “L”.

The wheel barrow main body 106 shape described above is exemplary, and should not be construed as limiting. Any other wheel barrow main body 106 shape is contemplated within the present disclosure scope.

The present disclosure further describes the wheel barrow cover 104 (or barrow topper) that may be attached to the wheel barrow 102. Specifically, the wheel barrow cover 104 may be attached to the wheel barrow main body 106. The wheel barrow cover 104 may provide additional capacity or storage volume by extending the use of the wheel barrow main body 106 beyond the standard edge/sidewalls of the wheel barrow main body 106.

The user may removably attach the wheel barrow cover 104 to the wheel barrow main body 106, at the main body top end 114. In an exemplary aspect, the user may removably attach the wheel barrow cover 104 to the main body top end 114 (e.g., the first rim 118 located at the main body top end 114) via one or more connectors 122. In some aspects, the connectors 122 may be clamps or latches. In other aspects, the connectors 122 may be any other components/devices which enable a snug and fitted enclosure. Any number of connectors 122 may be used to connect the wheel barrow cover 104 to the wheel barrow main body 106. The first rim 118 may provide support and facilitate the connector 122 to connect the wheel barrow cover 104 to the wheel barrow main body 106.

In some aspects, a wheel barrow main body profile may be same as a wheel barrow cover profile, which may facilitate the wheel barrow cover 104 to increase (e.g., double) the wheel barrow 102 storage capacity. The profile may include physical dimensions, design characteristics or shape, and/or the like. Thus, the shape and dimensions (e.g., height, length, thickness and depth) associated with the wheel barrow main body 106 may be equivalent to the shape and dimensions associated with the wheel barrow cover 104. Since the wheel barrow cover profile is same as the wheel barrow main body profile, the wheel barrow cover 104 is not a flat cover. The wheel barrow cover 104 may completely cover the main body top end 114 when the wheel barrow cover 104 may be attached to the wheel barrow main body 106.

The wheel barrow cover 104 may include a cover top end 124 (or cover top wall 124) and a cover bottom end 126. The cover top end 124 may be a closed end and the cover bottom end 126 may be an open end. The cover bottom end 126 may contact the main body top end 114 when the user attaches the wheel barrow cover 104 to the wheel barrow main body 106. In some aspects, the cover bottom end 126 may include a second rim 128 that may be positioned on an entire periphery of the cover bottom end 126, similar to the first rim 118. The second rim 128 may be a circular or oval structure, which provides a strong edge that reinforces the wheel barrow cover structure. The second rim 128 may contact the first rim 118 when the user attaches the wheel barrow cover 104 to the wheel barrow main body 106. The connector 122 may engage with the first rim 118 and the second rim 128 to attach the wheel barrow cover 104 and the wheel barrow main body 106. Thus, the first rim 118 and the second rim 128 facilitates attachment of the wheel barrow cover 104 with the wheel barrow main body 106.

The wheel barrow cover 104 may include sidewalls including a cover front sidewall 130a, a cover back sidewall 130b, a cover left sidewall 130c, and a cover right sidewall 130d. The cover front sidewall 130a may be located towards the wheel barrow front end when the user attaches the wheel barrow cover 104 with the wheel barrow main body 106. Similarly, the cover back sidewall 130b may be located towards the wheel barrow back end when the user attaches the wheel barrow cover 104 with the wheel barrow main body 106. In some aspects, the interior surfaces of the cover front sidewall 130a, the cover back sidewall 130b, the cover left sidewall 130c, the cover right sidewall 130d, and the cover top wall 124 may contact the material when the material may be loaded in the wheel barrow 102 and the wheel barrow cover 104 may be attached with the wheel barrow main body 106. In some aspects, the cover front sidewall 130a may be disposed at a second predefined angle “B” relative to the cover top wall 124, as shown in FIG. 3. In an exemplary aspect, the second predefined angle “B” may be equivalent to the first predefined angle “A”. The sidewalls 130a, 130b, 130c, 130d may act as extension of the sidewalls 120a, 120b, 120c, 120d, thereby increasing the wheel barrow main body 106 storage capacity, when the user attaches the wheel barrow cover 104 with the wheel barrow main body 106.

The wheel barrow cover 104 may include a cover front portion and a cover back portion. The cover front portion may be located at the wheel barrow front end and the cover back portion may be located at the wheel barrow back end. In some aspects, the cover front sidewall 130a may form the cover front portion. The cover back sidewall 130b, the cover left sidewall 130c, the cover right sidewall 130d, and the cover top wall 124 may form the cover back portion. In some aspects, a main body front portion profile is same as a cover front portion profile, and a main body back portion profile is same as a cover back portion profile. Stated another way, the structure and dimensions of the main body front portion are equivalent to the structure and dimensions of the cover front portion, and the structure and dimensions of the main body back portion are equivalent to the structure and dimensions of the cover back portion. In some aspects, a cover back portion length “L3” may be greater than a cover front portion length “L4”. In some aspects, the cover back portion length “L3” may be equivalent to the main body back portion length “L1”, and the cover front portion length “L4” may be equivalent to main body front portion length “L2”. The cover front portion length “L4” may be in a range of 10-40% of the total length “L” of the wheel barrow cover 104. In another exemplary aspect, the cover front portion length “L4” may be in a range of 15-20% or 10-50% of the total length “L”.

In some aspects, the cover front sidewall 130a dimensions/shape may be equivalent to the front sidewall 120a dimensions/shape. The cover front sidewall 128a may be slanted (at a predefined angle (which is not 90 degrees) relative to the cover top wall 124) and curved (or have arc-shape) similar to the front sidewall 120a. In some aspects, a radius of curvature associated with the cover front sidewall 130a may be equivalent to a radius of curvature associated with the front sidewall 120a. In addition, a front sidewall 120a height “H1” may be equivalent to a cover front sidewall 130a height “H2”.

The cover back sidewall 130b dimensions (e.g., height, length, etc.) may be equivalent to the back sidewall 120b dimensions/shape. Further, the cover left sidewall 130c dimensions/shape (e.g., height, length, etc.) may be equivalent to the left sidewall 120c dimensions/shape. Furthermore, the cover right sidewall 130d dimensions/shape (e.g., height, length, etc.) may be equivalent to the right sidewall 120d dimensions/shape.

In some aspects, the cover front portion may be pivotably connected to the cover back portion such that a cover front sidewall 130a plane may rotate relative to a cover top wall 124 plane. The cover front portion may be pivotably connected to the cover back portion via a hinge 132. Stated another way, the cover front sidewall 130a may be pivotably connected to the cover top wall 124 via the hinge 132. In an exemplary aspect, the hinge 132 may be a piano hinge. In other aspects, the hinge 132 may be any other type of hinge.

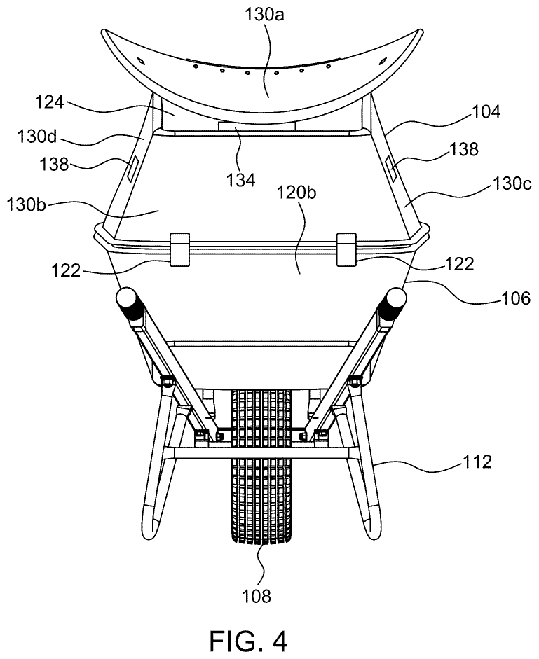

The cover front portion (or the cover front sidewall 130a) may be configured to move between an open position and a closed position. In the closed position, the wheel barrow cover 104 may completely cover the wheel barrow main body 106, and may not allow/enable loading or unloading of material to/from the wheel barrow main body 106 and prevent spillage of material from the front end, the rear end, and the sides of wheel barrow 102. In the open position, the wheel barrow cover 104 may partially uncover (or partially cover) the wheel barrow main body 106. In some aspects, in the open position, the cover back portion may be attached to the wheel barrow main body 106 (e.g., to the wheel barrow back portion) via the connector 122. In the open position, the cover front portion may be detached from the wheel barrow main body 106 (e.g., from the wheel barrow front portion) and may latch (or may be positioned) on the cover back portion (as shown in FIG. 4).

In some aspects, when the wheel barrow cover 104 is in the fully open position, the cover front portion exterior surface may contact the cover top end 124 exterior surface. In some aspects, the cover back portion may include a rubber grip or a clamp 134 to secure the cover front portion to the cover back portion roof in the fully open position (as shown in FIG. 4), to prevent the wheel barrow cover 104 from closing during material dumping or loading/unloading operation. The cover front portion may latch on the cover back portion via the rubber grip or clamp 134. Since, in the open position, the cover back portion is connected to the wheel barrow main body 106 and not disengaged from the wheel barrow main body 106, the wheel barrow cover 104 prevents spillage of material from the sides or the rear end of the wheel barrow 102 during loading and unloading from the front end (specifically, via the wheel barrow cover 104 in the open position). The closed position of the cover front portion is depicted in FIG. 1, and the open position of the cover front portion is depicted in FIGS. 2 and 4.

The user may keep the cover front portion in the closed position when the user may be transporting the material from the first location to the second location. In the closed position, the wheel barrow cover 104 may prevent spillage of material from the wheel barrow main body 106. The user may move the cover front portion from the closed position to the open position during the material loading or unloading from the wheel barrow main body 106.

In further aspects, the cover front portion (or the cover front sidewall 128a) may include a handle 136. The handle 136 may be located at the cover front sidewall 130a exterior surface. The user may use the handle 136 to move the cover front portion between the open position and the closed position.

In some aspects, the wheel barrow main body 106 and the wheel barrow cover 104 may be made of same material. Alternatively, the wheel barrow main body 106 and the wheel barrow cover 104 may be made of different material. In some aspects, the wheel barrow main body 106 and/or the wheel barrow cover 104 may be made of plastic. In further aspects, the wheel barrow main body 106 and/or the wheel barrow cover 104 may be made of steel or aluminum.

In an exemplary aspect, the user may use the wheel barrow 102 to burn the material stored inside the wheel barrow main body 106. The user may attach the wheel barrow cover 104 to the wheel barrow main body 106, load the material in the wheel barrow main body 106, and then burn the material. The user may keep the cover front portion in the closed position when the material may be burning. In some aspects, the wheel barrow cover 104 may additionally include an adjustable air vent 138 that enables air to flow inside a wheel barrow interior portion, which may facilitate the material combustion. The adjustable air vent 138 may be positioned on the cover top wall 124 (e.g., at a center position). In addition, the adjustable air vent 138 may be positioned on one or more sidewalls (e.g., on the sidewalls 130c and 130d). The user may open or close the adjustable air vent 138 by using a rotation mechanism, a sliding mechanism, and/or the like. As described above, in some aspects, the wheel barrow main body 106 and the wheel barrow cover 104 may be made of steel. Use of steel may enable the wheel barrow main body 106 and the wheel barrow cover 104 to burn the material within the wheel barrow main body 106, thereby allowing an individual to burn debris or material as the user collects it or thereafter within the existing wheel barrow. After burning, the user may move the cover front portion from the closed position to the open position and unload the ashes from the wheel barrow main body 106.

In addition, the user may use the wheel barrow 102 as a mixer to mix a first material with a second material. In this case, the wheel barrow cover 104 may prevent spillage of material during the mixing operation.

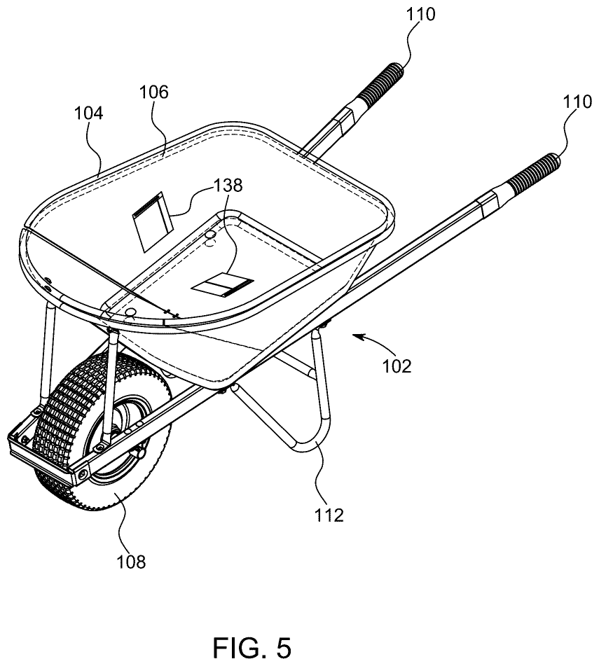

FIG. 5 depicts an example storage position of the wheel barrow cover 104 inside the wheel barrow main body 106 in accordance with the present disclosure. When the wheel barrow cover 104 may not be in use, the user may detach the wheel barrow cover 104 from the wheel barrow main body 106, invert the wheel barrow cover 104, and position the wheel barrow cover 104 inside the wheel barrow main body 106. Since the wheel barrow cover profile is same as the wheel barrow main body profile as described above, the wheel barrow cover 104 may snuggly fit inside the wheel barrow main body 106. In the storage position, the cover top wall 124 may contact the main body bottom wall 116. In addition, the sidewalls 130a, 130b, 130c, 130d may contact the respective sidewalls 120a, 120b, 120c, 120d when the wheel barrow cover 104 is snuggly fit inside the wheel barrow main body 106. In addition, the second rim 128 may engage with the first rim 118 in the storage position. The first rim 118 may provide support to the second rim 128 in the storage position. In the storage position, the wheel barrow main body 106 may completely enclose the wheel barrow cover 104. Thus, the wheel barrow cover 104 may not require any additional storage space when the wheel barrow cover 104 may not be in use.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc., should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A wheel barrow comprising:
a wheel barrow main body having a main body top end and a main body bottom end, wherein the wheel barrow main body comprises a container configured to store materials; and
a wheel barrow cover configured to be attached to the main body top end, wherein the wheel barrow cover comprises a cover front portion and a cover back portion, wherein the cover front portion is pivotally connected to the cover back portion via a hinge, and wherein the cover front portion is configured to move between an open position and a closed position;
wherein a profile of the wheel barrow main body is same as a profile of the wheel barrow cover.

2. The wheel barrow of claim 1, wherein the wheel barrow main body comprises a rim at the main body top end.

3. The wheel barrow of claim 2, wherein the wheel barrow cover is removably attached to the rim via a connector.

4. The wheel barrow of claim 3, wherein the connector is a clamp.

5. The wheel barrow of claim 2, wherein the wheel barrow main body comprises a main body front portion and a main body back portion, wherein a profile of the main body front portion is same as a profile of the cover front portion, and wherein a profile of the main body back portion is same as a profile of the cover back portion.

6. The wheel barrow of claim 5, wherein the wheel barrow main body comprises a front sidewall, a back sidewall, a left sidewall, a right sidewall, and a main body bottom wall.

7. The wheel barrow of claim 6, wherein the front sidewall has a curved shape.

8. The wheel barrow of claim 6, wherein the front sidewall is disposed at a predefined angle relative to the main body bottom wall, and wherein the predefined angle is different from 90 degrees.

9. The wheel barrow of claim 5, wherein a cover back portion length is greater than a cover front portion length.

10. The wheel barrow of claim 5, wherein the cover front portion comprises a handle.

11. The wheel barrow of claim 5, wherein the wheel barrow cover comprises an adjustable air vent that enables air to flow inside a wheel barrow interior portion.

12. The wheel barrow of claim 5, wherein the wheel barrow cover is configured to increase a storage capacity of the wheel barrow when the wheel barrow cover is attached to the main body top end.

13. The wheel barrow of claim 1, wherein the wheel barrow main body and the wheel barrow cover are made of same material.

14. The wheel barrow of claim 1, wherein the wheel barrow main body and the wheel barrow cover are made of different material.

15. The wheel barrow of claim 1, wherein the wheel barrow main body and the wheel barrow cover are made of plastic.

16. The wheel barrow of claim 1, wherein the wheel barrow main body and the wheel barrow cover are made of steel.

17. The wheel barrow of claim 1, wherein a depth of the wheel barrow main body is equivalent to a depth of the wheel barrow cover.

18. The wheel barrow of claim 1, wherein the cover back portion comprises a rubber grip or clamp to secure the cover front portion to a roof of the cover back portion in the open position.

19. A wheel barrow comprising:
a wheel barrow main body having a main body top end and a main body bottom end, wherein the wheel barrow main body comprises a container configured to store materials; and
a wheel barrow cover configured to be attached to the main body top end, wherein the wheel barrow cover comprises a cover front portion and a cover back portion, wherein the cover front portion is pivotally connected to the cover back portion via a hinge, and wherein the cover front portion is configured to move between an open position and a closed position;
wherein a profile of the wheel barrow main body is same as a profile of the wheel barrow cover, and
wherein a cover back portion length is greater than a cover front portion length.

20. A wheel barrow comprising:
a wheel barrow main body having a main body top end and a main body bottom end, wherein the wheel barrow main body comprises a container configured to store materials; and
a wheel barrow cover configured to be attached to the main body top end, wherein the wheel barrow cover comprises a cover front portion and a cover back portion, wherein the cover front portion is pivotally connected to the cover back portion via a hinge, and wherein the cover front portion is configured to move between an open position and a closed position;
wherein a profile of the wheel barrow main body is same as a profile of the wheel barrow cover, and
wherein a depth of the wheel barrow main body is equivalent to a depth of the wheel barrow cover.
